(19) United States
(12) Patent Application Publication
(10) Pub. No.: US 2024/0420585 A1
(43) Pub. Date: Dec. 19, 2024

(54) APPLYING COGNITIVE DIAGNOSTIC MODELING AND DEEP LEARNING ALGORITHMS TO IMPROVE KNOWLEDGE TRANSFER PROGRESS

(71) Applicant: International Business Machines Corporation, Armonk, NY (US)

(72) Inventors: Yang Du, San Jose, CA (US); Andrew Low, Stittsville (CA); Jennifer Mulsow, Cedar Park, TX (US)

(21) Appl. No.: 18/336,160

(22) Filed: Jun. 16, 2023

(51) Int. Cl. G09B 7/02; G06N 5/02

(52) U.S. Cl. CPC G09B 7/02; G06N 5/02

(57) ABSTRACT

Embodiments of the present invention provide an approach for applying cognitive diagnostic modeling (CDM) and deep learning algorithms to improve knowledge transfer (KT) progress. Specifically, the approach aims to improve the process of transferring knowledge by breaking down a learning task into smaller subtasks that are related to a specific learning goal. The provided responses for each subtask are then evaluated using a deep learning algorithm, which generates a continuous score based on the difference between the provided response and the expected response. Each continuous score is then converted into a binary value to obtain a set of binary values. Based on the set of binary values, a diagnostic report is generated that reflects the progress of knowledge transfer for the assigned learning task. This approach allows for a more detailed and accurate assessment of the learning process, which can help to identify areas where further improvement is needed.

### TECHNICAL FIELD

The present invention relates to knowledge transfer, and more specifically to embodiments for applying cognitive diagnostic modeling (CDM) and deep learning algorithms to improve knowledge transfer (KT) progress.

### BACKGROUND

Knowledge transfer refers to the process of sharing information between individuals or organizations, often involving the exchange of tacit knowledge (i.e., experiential knowledge not easily conveyed via written language). Effective knowledge transfer enables individuals to improve their job performance and promotes organizational growth and innovation. When learning new concepts or technologies, knowledge transfer plays a crucial role in moving beyond mere comprehension to active application and utilization. This process includes both unconscious and conscious components, including observation, interaction, experimentation, and reflection. Successful knowledge transfer is dependent upon several factors, including clear instructions, engaging content presentation, adequate resources, opportunities for practice and reinforcement, as well as direct support mechanisms such as coaching or mentoring. By effectively communicating, demonstrating relevance, offering timely assistance, and encouraging growth mindset, knowledge transfer accelerates adaptation, retention, and dissemination. Ultimately, successful knowledge transfer empowers practitioners while driving continuous improvement.

### SUMMARY

Embodiments of the present invention provide an approach for applying cognitive diagnostic modeling (CDM) and deep learning algorithms to improve knowledge transfer (KT) progress. Specifically, the approach aims to improve the process of transferring knowledge by breaking down a learning task into smaller subtasks that are related to a specific learning goal. The provided responses for each subtask are then evaluated using a deep learning algorithm, which generates a continuous score based on the difference between the provided response and the expected response. Each continuous score is then converted into a binary value to obtain a set of binary values. Based on the set of binary values, a diagnostic report is generated that reflects the progress of knowledge transfer for the assigned learning task. This approach allows for a more detailed and accurate assessment of the learning process, which can help to identify areas where further improvement is needed.

A first aspect of the present invention provides a method for improving a progress of knowledge transfer process, comprising: receiving an assigned learning task; decomposing the assigned learning task into a plurality of subtasks based on a predefined relationship to a learning goal; evaluating, using a deep learning algorithm, a provided response related to each learning subtask to generate a continuous score for each provided response based on a difference between the provided response and an expected response; converting each continuous score to a binary value to obtain a set of binary values; and generating, based on the set of binary values, a diagnostic report that reflects a knowledge transfer progress related to the assigned learning task.

A second aspect of the present invention provides a computing system for improving a progress of knowledge transfer process, comprising: a processor; a memory device coupled to the processor; and a computer readable storage device coupled to the processor, wherein the storage device contains program code executable by the processor via the memory device to implement a method, the method comprising: receiving an assigned learning task; decomposing the assigned learning task into a plurality of subtasks based on a predefined relationship to a learning goal; evaluating, using a deep learning algorithm, a provided response related to each learning subtask to generate a continuous score for each provided response based on a difference between the provided response and an expected response; converting each continuous score to a binary value to obtain a set of binary values; and generating, based on the set of binary values, a diagnostic report that reflects a knowledge transfer progress related to the assigned learning task.

A third aspect of the present invention provides a computer program product for improving a progress of knowledge transfer process, comprising, the computer program product comprising a computer readable storage device, and program instructions stored on the computer readable storage device, to: receive an assigned learning task; decompose the assigned learning task into a plurality of subtasks based on a predefined relationship to a learning goal; evaluate, using a deep learning algorithm, a provided response related to each learning subtask to generate a continuous score for each provided response based on a difference between the provided response and an expected response; convert each continuous score to a binary value to obtain a set of binary values; and generate, based on the set of binary values, a diagnostic report that reflects a knowledge transfer progress related to the assigned learning task.

### BRIEF DESCRIPTION OF THE DRAWINGS

FIG. 1 depicts a block diagram illustrating an example of an environment for the execution of at least some of the computer code involved in performing the inventive methods, in accordance with embodiments of the present invention.

FIG. 2 depicts a block diagram of a system architecture involved in performing the inventive methods, in accordance with embodiments of the present invention.

FIG. 3A-D depict a diagram of a cognitive diagnosis modeling learning paradigm involved in performing the inventive methods, in accordance with embodiments of the present invention.

FIG. 4 depicts a flowchart diagram related to improving knowledge transfer progress, in accordance with an embodiment of the present invention.

FIG. 5 depicts a workflow diagram related to improving knowledge transfer progress, in accordance with an embodiment of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

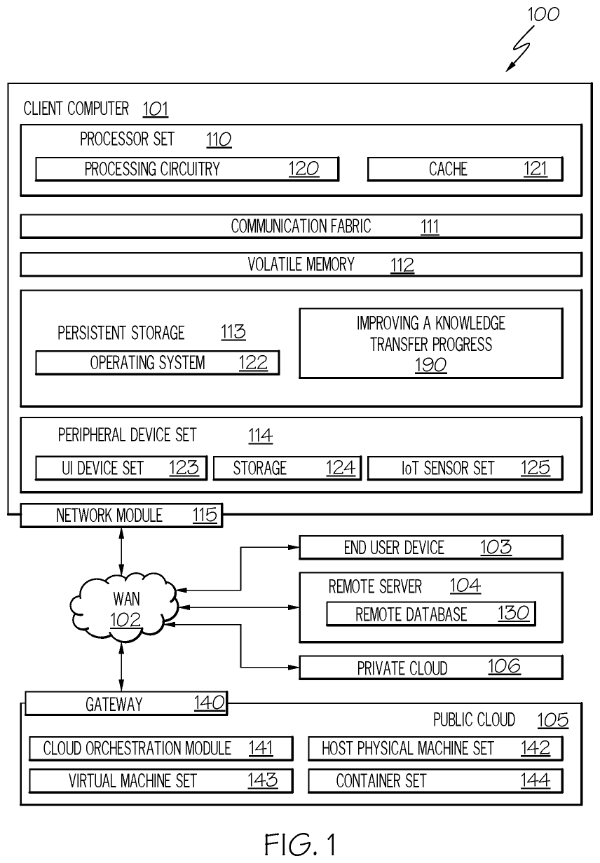

Computing environment 100 of FIG. 1 contains an example of an environment for the execution of at least some of the computer code involved in performing the inventive methods, such as improving a knowledge transfer progress technique 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

The current approach to knowledge transfer in technical fields, such as software engineering and data science, often lacks structure and evaluation. Typically, mentors will provide mentees with extensive resources, including code files and presentations, and then leave them to learn independently. Without proper evaluation, both parties struggle with efficiency and effectiveness. Mentors don't know if their mentees fully comprehend what they should do during future projects, and mentees feel less motivated since there are no tangible benefits to completing their studies. To solve this issue, a novel way of using cognitive diagnosis modeling (CDM) can offer substantial help in technical knowledge transfer (KT).

CDM is a technique used to understand how individuals solve problems by breaking down their solutions into smaller components called subtasks. CDM is a tool that goes beyond simply breaking down problems into smaller tasks. It is a paradigm based on latent class theory that enables creation of a comprehensive profile of a student's learning attributes, rather than just a single score. For instance, imagine a math test where two students score an 80 out of 100. With CDM, their mastery level of specific learning attributes can be evaluated such as addition, fraction, geometry, or trigonometry. This allows the granular differences in their mastery of particular learning attributes to be measured, even if they both received the same overall score. Task decomposition and learning attribution decomposition are just a few aspects of CDM, highlighting its ability to provide a more detailed and nuanced understanding of students' learning abilities.

These subtasks are assessed using inference questions to identify the learner's strengths and weaknesses. The process typically combines different types of data, including verbal protocols, background knowledge assessments, and observations, to create a more complete picture of the learner's thinking processes. Educational institutions commonly use CDM for assessments as it provides thorough reporting for each student according to specific skills or attributes. However, implementing CDM into technical training would require adaptations since it typically requires multiple-choice or constructed response questions with definitive right/wrong solutions. Therefore, technical KT scenarios call for modifications before integrating evaluation methods. To accomplish this objective, the proposed solution provides an approach to effectively leverage CDM for evaluating the learning progress of mentees in technical KT.

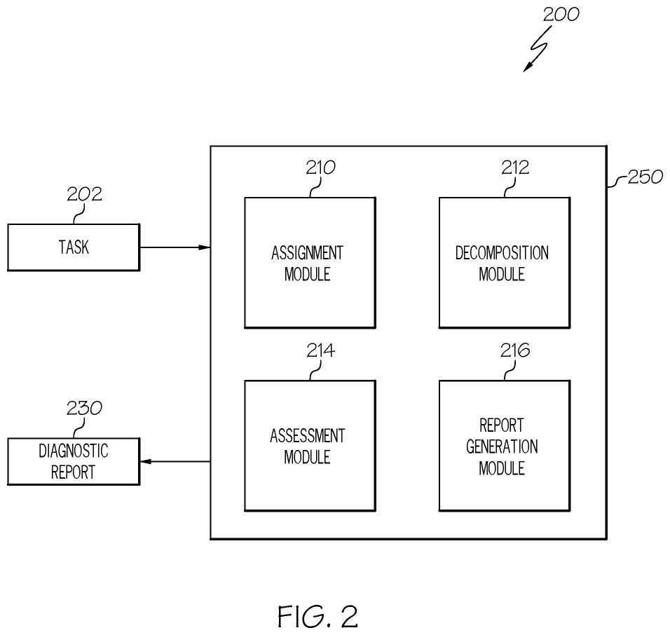

FIG. 2 depicts a block diagram of one or more components of a system environment 200 by which services provided by a knowledge transfer progress (KTP) engine may be offered as cloud services, in accordance with an embodiment of the present disclosure. In accordance with some embodiments, the KTP engine 250 is configured to provide an accurate assessment of a mentee's learning progress and helps a mentor identify areas where further guidance and support may be required. As used herein, an “engine” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, an “engine” can refer to a combination of a hardware processing circuit and machine-readable instructions (software and/or firmware) executable on the hardware processing circuit.

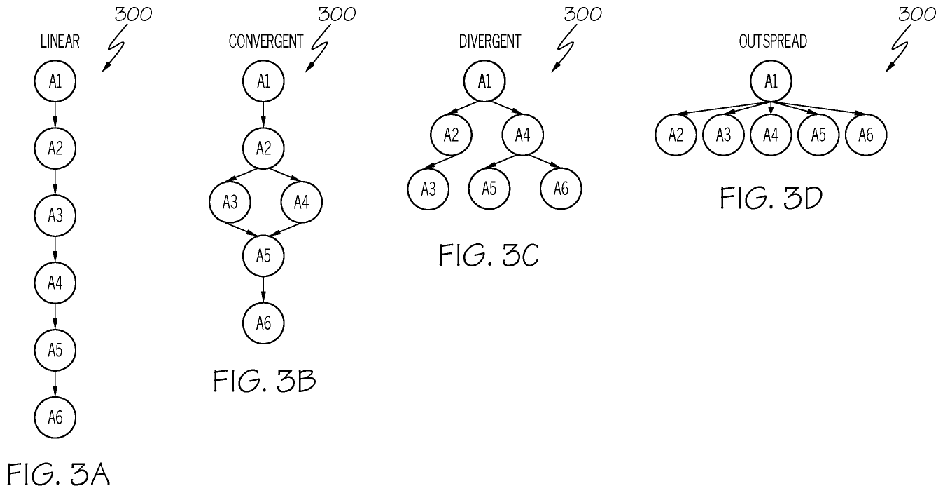

As shown in FIG. 2, KTP engine 250 may include one or more modules, such as assignment module 210, decomposition module 212, assessment module 214, and report generation module 216. The approach taken by KTP engine 250 involves a process integrated into a KT system that enables mentors to assign learning tasks and mentees to submit their completed assignments. Assignment module 210 is configured to receive a task 202 that has been assigned by a mentor to a mentee. A mentor is an experienced and trusted individual who provides guidance, support, and advice to a less experienced person, known as a mentee. The mentor shares her knowledge and expertise to help the mentee develop skills, achieve goals, and reach their full potential. \ Decomposition module 212 is configured to divide or break down a task assigned by a mentor into smaller subtasks that are aligned with the learning objectives and their interrelation. An example of CDM learning paradigm 300 is shown in FIGS. 3A-D, which illustrates four types of attribute hierarchies. FIG. 3A shows a linear attribute hierarchy. FIG. 3B shows a convergent attribute hierarchy. FIG. 3C shows a divergent attribute hierarchy. FIG. 3D shows an outspread attribute hierarchy. Each demonstrate the interdependencies of attributes. CDM learning paradigm 300 arranges learning tasks according to learning goals, thus facilitating the transfer of knowledge.

CDM learning paradigm 300 allows the mentor to break down the task based on the necessary learning attributes and skills. This theoretical framework explains how a mentee can gain knowledge and abilities through cognitive development, with experience, interaction, and reflection playing a crucial role. The CDM learning paradigm 300 proposes that learning occurs in stages, with each stage building on the previous one. The CDM learning paradigm 300 provides a model for comprehending an individual's learning and development over time.

When a mentor assigns a task to a mentee, she might not realize that the task requires multiple learning skills/attributes. For example, a task of running a descriptive analysis on data requires a mentee to know where to access the data, correctly download/load the data into a programming environment, understand what descriptive analysis is, and understand coding to compute descriptive statistics such as means and standard deviations. With the CDM learning paradigm 300, a mentor can understand the relationship among these attributes and decompose the task into subtasks. The CDM learning paradigm 300 allows the mentor to analyze the attributes of the task and their relationships through a process known as cognitive task analysis. This process involves breaking down the task into smaller, more manageable subtasks and identifying the knowledge and skills required to complete each subtask. By understanding the relationships among the attributes and subtasks, the mentor can develop a more effective training program and provide targeted support to the learner.

The CDM learning paradigm thus enables the mentor to decompose the task into subtasks and identify the necessary knowledge and skills for each subtask. In the descriptive analysis example, the task can be decomposed linearly into three subtasks: 1) know which database to query; 2) retrieve the correct data; and 3) use correct functions/commands in a coding environment to run the descriptive analysis. By decomposing a task into subtasks, the mentor can accurately measure each skill/attribute separately, which is essential for future grading and diagnosis.

Assessment module 214 is configured to assess, using a deep learning regression algorithm, differences between a mentee's responses and expected responses to a set of subtasks to generate a continuous score (e.g., 87 out of 100) for each subtask based on the differences. A continuous score, in the context of machine learning and statistical analysis, refers to a numerical value or a real number that represents the degree or likelihood of a certain outcome or event. It is often associated with prediction or estimation tasks. Unlike discrete categories or labels (e.g., “yes” or “no,” “true” or “false”), a continuous score provides a measure of the intensity, magnitude, or probability associated with an event or prediction. It typically ranges over a continuous interval, allowing for finer-grained distinctions or quantification. In an embodiment, the continuous score can range between 0-100. Scores closer to 100 demonstrate a near perfect match between these two sets of responses, while a lower score indicates greater variance relative to expected responses.

As stated, a mentee will provide a response for each subtask that can be compared against an expected response for each subtask. In an embodiment, the mentee can utilize a chatbot to assist in providing responses. Knowledge transfer using a chatbot can occur through interactive communication, where a mentee poses questions about a subtask or assigned task that she wishes to learn more about. The chatbot then provides relevant information or resources to aid learning and understanding. Chatbots can also actively monitor a mentee's progress through quizzes, assessments, or other tracking methods in order to ensure comprehension and proficiency. In an embodiment, a natural language processing algorithm can be used to analyze a chatbot conversation to capture the difference between a mentee's responses and references responses. Natural language processing (NLP) is a machine learning technology that gives computers the ability to interpret, manipulate, and comprehend human language.

Once a mentee submits her responses for each subtask, assessment module 214 will leverage a trained deep learning regression algorithm to grade the responses. A trained deep learning regression algorithm is one that has been developed by feeding large amounts of data into a neural network and allowing it to learn from the patterns in the data. This allows the model to build a mathematical function that predicts the target variable based on input features and parameters learned during a training process which helps distinguish important variables from irrelevant ones. After each pass, weights are updated and the performance increases until there is no improvement on evaluation metrics like mean square error, cross entropy, etc. Then, the final set of weights are saved to make predictions on future inputs that have similarities with previous training data.

The deep learning regression algorithm uses various features to capture the discrepancies between a mentee's responses and the reference responses provided by a mentor. In the descriptive analysis example, features can include differences between the SQL query used by the mentee and mentor, differences in retrieved data, and the time spent on each task. A regression model used by the algorithm can predict a score based on these features. A regression model is a statistical approach used to understand and quantify the relationship between a dependent variable and one or more independent variables. It can be used for predicting or estimating numerical values based on the input of other variables. In regression analysis, the dependent variable is often referred to as the “outcome” or “target” variable, while the independent variables are known as “predictors” or “features.” The model seeks to find a mathematical equation that best represents the relationship between the variables, allowing for predictions or inferences about the dependent variable based on the values of the independent variables.

As the subtasks are related, transfer learning techniques can be used to transfer the model parameters trained on previous tasks to the next task. Transfer learning allows a model to leverage knowledge learned from one task and apply it to a different but related task. Instead of training a model from scratch, transfer learning uses pre-trained models that have been trained on large datasets. By utilizing the learned features and representations from these pre-trained models, transfer learning enables the efficient training of models on smaller or specialized datasets, improving their performance and reducing training time. This avoids the need for a separate regression model for each subtask.

Assessment module 214 converts the generated continuous scores into binary scores (i.e., ‘0’ or ‘1’) based on related thresholds in a learning algorithm. Each threshold value can be a model-indicated threshold or a manual threshold. In an embodiment, the thresholds in the learning algorithm can be determined through a process called model training or optimization. During training, the algorithm is presented with a set of input data along with corresponding output labels or target values. The algorithm adjusts its internal parameters iteratively to minimize the difference between the predicted outputs and the true outputs. A threshold, in this context, refers to a decision boundary that helps classify or make predictions based on the algorithm's output. The exact determination of the threshold depends on the specific learning algorithm and the nature of the problem being solved. It can be set based on domain knowledge, statistical analysis, or through a validation process. The threshold is chosen to balance the trade-off between false positives and false negatives based on the problem's requirements and the relative costs of different types of errors.

Once the predicted scores and score thresholds are determined, assessment module 214 classifies each response as a ‘1’ if its score is above the threshold, or ‘0’ otherwise. This process allows for objective grading and classification of a mentee's responses, which is essential for accurate diagnosis and feedback. The binary scores obtained are used as input for a cognitive diagnostic model (CDM). CDM is a mathematical algorithm that is commonly used to analyze data from educational assessments, especially standardized tests. Its main goal is to identify the distinct knowledge components that underlie students' answers. These knowledge components can include a range of factors that could affect student performance, such as their understanding of concepts, foundational skills in a particular subject, and problem-solving abilities. CDM is particularly useful in diagnosing skills and abilities in areas where traditional multiple-choice tests may fall short.

By going beyond just breaking down problems into smaller tasks, CDM provides a more comprehensive profile of a student's learning attributes than just a single score. For example, a test may only measure general recall knowledge, rather than actual skill proficiency. However, CDM can partition students into different proficiency levels by identifying errors made during problem-solving tasks. This approach allows for a more nuanced understanding of a student's strengths and weaknesses in specific areas, making it a valuable tool for mentors.

Report generation module 216 is configured to receive the binary scores and generate, using a CDM model, a comprehensive diagnostic report 230 on a mentee's progress in each learning goal, skill, or attribute. This report highlights the learning attributes that the mentee has acquired and those that they have yet to acquire. The report provides valuable insights into the mentee's strengths and weaknesses, enabling a mentor to customize her approach and offer targeted feedback. This process ensures effective monitoring and evaluation of the mentee's progress, helping them acquire the necessary skills and knowledge to succeed in a particular field.

This approach offers numerous advantages to both mentors and mentees in KT sessions. Firstly, it introduces evaluation to the KT process, enabling mentors and mentees to monitor progress. This evaluation not only motivates mentees to learn more thoroughly but also makes it easier for mentors to track their progress. Furthermore, the detailed diagnostic report generated from CDM provides a comprehensive understanding of mentees' learning and KT efficiency. Unlike large-scale tests that only provide an overall score, CDM allows for assessing how well mentees grasp each learning goal, attribute, or skill, enabling mentors to tailor future learning tasks to focus on areas where skills have yet to be learned.

Additionally, the deep learning grading algorithms integrated into the system not only save time and effort in grading but also leverage modeling features that humans may not capture, resulting in more precise scores. Lastly, this approach does not assume or require mentors in KTs to be teaching experts. While mentors may have expert knowledge of projects, they may not excel at teaching them to others. The CDM-assisted task assignment system guides mentors in assigning tasks and enables them to teach more effectively during the KT process.

The proposed approach differs from previous attempts in several ways. Firstly, while CDM is typically used in educational and psychological contexts, it is not universally adopted in technical knowledge transfer due to its limitations, such as requiring binary responses. This approach is the first to apply CDM to the domain of technical knowledge transfer, which is a significant departure from prior applications. Secondly, this approach is unique in its focus on technical knowledge transfer, which differs from other positions like HR or customer service. The tasks involved in software engineering or data science are not as standardized, which makes it challenging to design standardized tasks or evaluate task performance. Finally, this approach is innovative in its use of a deep learning regression algorithm to make CDM applicable to knowledge transfer, which has not been attempted before.

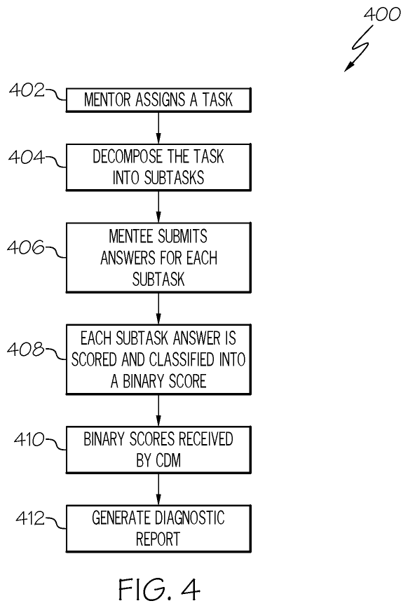

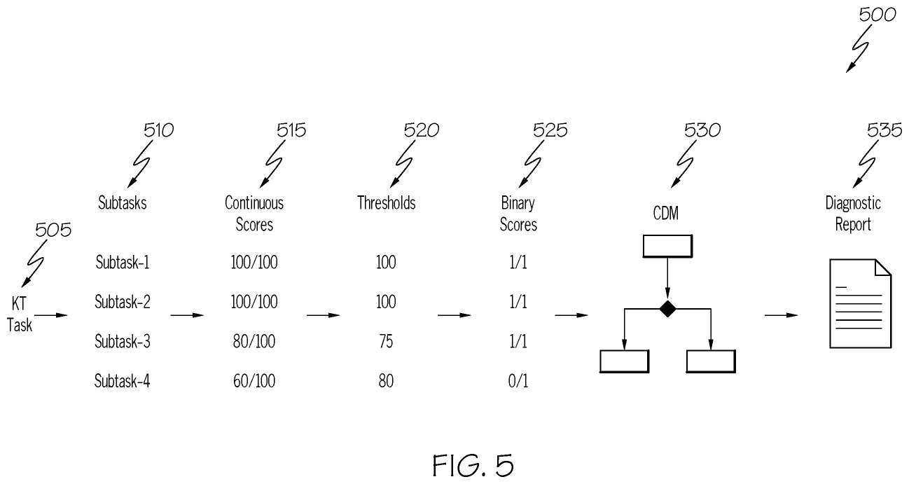

FIG. 4 depicts a flow diagram 400 for applying cognitive diagnostic modeling (CDM) and deep learning algorithms to improve knowledge transfer (KT) progress. The steps shown in FIG. 4 are described with reference to the workflow diagram 500 shown in FIG. 5. At 402, a mentor assigns a knowledge transfer (KT) task 505. As shown in FIG. 5, an example KT task 505 is provided for illustrative purposes only and should not be construed as limiting the scope of the present disclosure in any way. In this example, KT task 505 is provided by a mentor to a mentee for the mentee to run a descriptive analysis from required data. KT task 505 is received by assignment module 210 (FIG. 2). At 404, decomposition module 212 (FIG. 2) divides KT task 505 given by the mentor into subtasks based on learning objectives and their interconnectivity. KT task 505 has four steps, labeled as subtasks 510, including step 1 (Subtask_1): having access to a database; Step 2 (Subtask_2): knowing which database to search; step 3 (Subtask_3): writing a correct SQL query; and step 4 (Subtask_4): performing accurate data analysis.

At 406, the mentee responds (e.g., submits answers) for each subtask. Assessment module 214 (FIG. 2) will use a trained deep learning regression algorithm to generate continuous scores (or grades) 515 from the mentee's responses. The grading criteria can be customized, such as response accuracy or deviation from the expected response. Transfer learning can also be utilized to share parameters between subtasks. This scoring process helps speed up manual reviews. The scores are displayed on a 0-100 scale, but any scale can be set. As shown, Subtask_1 and Subtask_2 received a score of 100, Subtask_3 received a score of 80, and Subtask_4 received a score of 60.

At 408, assessment module 214 converts the generated continuous scores into binary scores 525 (i.e., ‘0’ or ‘1’) based on thresholds 520. Thresholds 520 can be established by deep learning algorithms through a data-driven approach or manually assigned. A deep learning algorithm is a type of artificial intelligence (AI) that uses multiple layers of neural networks to analyze and learn from data in order to make predictions or decisions about new data. It is designed to mimic the way the human brain works, with each layer processing and interpreting information from the previous layer until it reaches a final output. A value of ‘1’ indicates a response was correct, while ‘0’ indicates an incorrect response from the mentee.

As shown, the first 3 subtasks received a binary score of ‘1’, while the last subtask received a ‘0’ based on its threshold. At 410, the binary scores are used as input for cognitive diagnostic model (CDM) 530. At 412, report generation module 216 (FIG. 2) receives the binary scores 525 to generate, using CDM model 530, comprehensive diagnostic report 535 related to the mentee's progress of assigned KT task 505. Diagnostic report 535 will relate to the mentor that the mentee can connect and query the correct database and the mentee's SQL query is correct, but the mentee needs more learning on how to perform an accurate data analysis. Further guidance is required for the mentee to refine her skills in this area.

To improve a knowledge transfer or mentoring process, the approach described herein provides more support to a mentor when assigning tasks using a CDM paradigm/attribute hierarchy. Additional response behaviors are collected from a mentee to better understand her learning process. A transfer learning and deep learning-based grading model is utilized to allow for continuous grading, which can later be integrated into the CDM model. A knowledge transfer progress learning (or diagnostic) report is generated, in addition to an overall score, to assist the mentor in evaluating the mentee's learning progress. The overall score reflects the level of knowledge transfer progress. The higher the overall score, the more effective the mentee is in utilizing the knowledge gained from their mentor or learning experiences to achieve her goals and enhance her performance.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for improving a progress of knowledge transfer process, comprising:
receiving an assigned learning task;
decomposing the assigned learning task into a plurality of subtasks based on a predefined relationship to a learning goal;
evaluating, using a deep learning algorithm, a provided response related to each learning subtask to generate a continuous score for each provided response based on a difference between the provided response and an expected response;
converting each continuous score to a binary value to obtain a set of binary values; and
generating, based on the set of binary values, a diagnostic report that reflects a knowledge transfer progress related to the assigned learning task.

2. The method of claim 1, further comprising converting, by the processor, each continuous score to a ‘1’ when the continuous score is greater or equal to a predefined threshold value or a ‘0’ when the continuous score is less than the predefined threshold.

3. The method of claim 2, wherein the predefined threshold is a model-indicated threshold or a manual threshold.

4. The method of claim 1, further comprising decomposing the assigned learning task into the plurality of subtasks using a cognitive diagnostic model learning paradigm.

5. The method of claim 4, wherein the cognitive diagnostic model learning paradigm organizes knowledge transfer learning tasks by learning goals.

6. The method of claim 1, wherein each continuous score is converted to a binary value based on a threshold in a learning algorithm.

7. The method of claim 1, wherein each provided response is an answer to a related learning subtask.

8. A computing system for improving a progress of knowledge transfer process, comprising:
a processor;
a memory device coupled to the processor; and
a computer readable storage device coupled to the processor, wherein the storage device contains program code executable by the processor via the memory device to implement a method, the method comprising:
receiving an assigned learning task;
decomposing the assigned learning task into a plurality of subtasks based on a predefined relationship to a learning goal;
evaluating, using a deep learning algorithm, a provided response related to each learning subtask to generate a continuous score for each provided response based on a difference between the provided response and an expected response;
converting each continuous score to a binary value to obtain a set of binary values; and
generating, based on the set of binary values, a diagnostic report that reflects a knowledge transfer progress related to the assigned learning task.

9. The computing system of claim 8, further comprising converting, by the processor, each continuous score to a ‘1’ when the continuous score is greater or equal to a predefined threshold value or a ‘0’ when the continuous score is less than the predefined threshold.

10. The computing system of claim 9, wherein the predefined threshold is a model-indicated threshold or a manual threshold.

11. The computing system of claim 8, further comprising decomposing the assigned learning task into the plurality of subtasks using a cognitive diagnostic model learning paradigm.

12. The computing system of claim 11, wherein the cognitive diagnostic model learning paradigm organizes knowledge transfer learning tasks by learning goals.

13. The computing system of claim 8, wherein each continuous score is converted to a binary value based on a threshold in a learning algorithm.

14. The computing system of claim 8, wherein each provided response is an answer to a related learning subtask.

15. A computer program product for improving a progress of knowledge transfer process, comprising, the computer program product comprising a computer readable storage device, and program instructions stored on the computer readable storage device, to:
receive an assigned learning task;
decompose the assigned learning task into a plurality of subtasks based on a predefined relationship to a learning goal;
evaluate, using a deep learning algorithm, a provided response related to each learning subtask to generate a continuous score for each provided response based on a difference between the provided response and an expected response;
convert each continuous score to a binary value to obtain a set of binary values; and
generate, based on the set of binary values, a diagnostic report that reflects a knowledge transfer progress related to the assigned learning task.

16. The computer program product of claim 15, further comprising program instructions stored on the computer readable storage device to convert, by the processor, each continuous score to a ‘1’ when the continuous score is greater or equal to a predefined threshold value or a ‘0’ when the continuous score is less than the predefined threshold.

17. The computer program product of claim 16, wherein the predefined threshold is a model-indicated threshold or a manual threshold.

18. The computer program product of claim 15, further comprising program instructions stored on the computer readable storage device to decompose the assigned learning task into the plurality of subtasks using a cognitive diagnostic model learning paradigm.

19. The computer program product of claim 18, wherein the cognitive diagnostic model learning paradigm organizes knowledge transfer learning tasks by learning goals.

20. The computer program product of claim 15, wherein each continuous score is converted to a binary value based on a threshold in a learning algorithm.
